(19) United States
(12) Patent Application Publication
(10) Pub. No.: US 2012/0328949 A1
(43) Pub. Date: Dec. 27, 2012

(54) LITHIUM ION SECONDARY BATTERY AND PRODUCTION METHOD OF SAME

(76) Inventor: Hiroyuki Yamaguchi, Susono-shi (JP)

(21) Appl. No.: 13/511,389

(22) PCT Filed: Feb. 22, 2010
(86) PCT No.: PCT/JP10/52606

§ 371 Date: May 23, 2012

(51) Int. Cl. H01M 4/38; H01M 10/04; H01M 4/50

(52) U.S. Cl. 429/224; 29/623.1

(57) ABSTRACT

Provided is a lithium ion secondary battery having a positive electrode active material containing Mn and exhibiting improved charge/discharge cycle characteristics. A secondary battery 10 is provided with a positive electrode 12 having a positive electrode active material containing manganese, a negative electrode 14 having a negative electrode active material, a non-aqueous electrolyte solution 20 interposed between the positive electrode 12 and the negative electrode 14, and an acidic group-containing polymer 18 arranged between the positive electrode active material and the negative electrode active material.

### TECHNICAL FIELD

The present invention relates to a lithium ion secondary battery provided with a positive electrode active material containing manganese.

### BACKGROUND ART

Lithium ion secondary batteries are provided with positive and negative electrodes having active materials that reversibly store and release lithium ions, and an electrolyte solution interposed between both of the electrodes, and which are charged and discharged by the migration of lithium ions between the electrodes. A typical example of a positive electrode active material is a lithium transition metal oxide such as lithium cobalt oxide or lithium nickel oxide. A typical example of a negative electrode active material is a carbon material such as graphite.

Patent Document 1 describes that characteristics such as initial coulombic efficiency can be improved by inhibiting reversible reactions of a battery by coating carbon particles with an acrylic acid-based polymer such as acrylonitrile or acrylic acid ester in a battery that uses a carbon material for the negative electrode.

### CITATION LIST

### Patent Literature

Patent Literature 1: Japanese Patent Application Laid-open No. H8-195197

### SUMMARY OF INVENTION

### Technical Problem

Growing expectations have been placed on positive electrode active materials containing manganese (Mn) as a constituent element thereof for use as inexpensive positive electrode materials. Lithium manganese oxide (encompasses that in which a portion of the Mn is substituted with another metal element) having a spinel crystal structure is a typical example of a positive electrode active material that contains Mn. However, in the case of positive electrode active materials containing Mn, charge/discharge cycle characteristics (such as reduced deterioration caused by charge/discharge cycling) of a lithium ion secondary battery constructed using these active materials tended to be lower than that of positive electrode active materials not containing Mn.

Therefore, an object of the present invention is to improve charge/discharge cycle characteristics in a lithium ion secondary battery provided with a positive electrode active material containing Mn.

### Solution to Problem

One factor that has been indicated to cause deterioration of lithium ion secondary batteries provided with a positive electrode active material containing Mn is the potential for the formation of a highly resistive film due to elution of divalent Mn derived from the positive electrode active material (for example, that which is able to be formed by the disproportionation of trivalent Mn to divalent Mn and tetravalent Mn) into the electrolyte solution, and the deposition thereof on the negative electrode. The formation of this highly resistive film can cause an increase in internal resistance (direct current resistance) of the battery that decreases battery capacity. The inventor of the present invention considered trapping Mn ions in a pathway by which Mn ions that have eluted from the positive electrode active material reach the negative electrode active material. It was then found that decreases in battery capacity are actually suppressed by arranging a polymer containing an acidic functional group between both active materials to trap the Mn ions, thereby leading to completion of the present invention.

One invention disclosed herein relates to a lithium ion secondary battery. This lithium ion secondary battery has a positive electrode having a positive electrode active material containing manganese (such as spinel-type lithium manganese oxide), and a negative electrode having a negative electrode active material. The battery is also provided with an electrolyte (typically, a non-aqueous electrolyte solution) interposed between the positive electrode and the negative electrode. This battery is further provided with an acidic group-containing polymer arranged between the positive electrode active material and the negative electrode active material.

According to a lithium ion secondary battery employing this configuration, Mn ions possibly elute from the positive electrode active material can be trapped by utilizing the acidic group (such as a —COOH group or -SO₃H group) of the acidic group-containing polymer. Thus, the phenomenon in which the eluted Mn forms a highly resistive film on the negative electrode can be prevented or suppressed.

In the present specification, the term “lithium ion secondary battery” refers to a secondary battery that uses lithium ions as electrolyte ions and is charged and discharged by the migration of lithium ions between positive and negative electrodes. The technology disclosed herein is typically applied to a lithium ion secondary battery of a form that does not use lithium metal (as a simple substance) in an electrode constituent material.

A preferable example of the acidic group-containing polymer is a polymer that contains at least one of acrylic acid and methacrylic acid as a monomer composition (such as polyacrylic acid). The polymer may be a homopolymer of acrylic acid or methacrylic acid, or a copolymer with other monomer(s). A preferable example of an acidic group-containing polymer is polyacrylic acid.

The acidic group-containing polymer can be arranged by removing a solvent from a solution in which the polymer is dissolved in the solvent (such as by drying the solution). An organic solvent (for example, a lower alcohol such as ethyl alcohol) can be preferably employed for the solvent. By arranging the acidic group-containing polymer by removing a solvent from an organic solvent solution in this manner, a lithium ion secondary battery that demonstrates higher charge/discharge cycle characteristics can be realized.

A location not in direct contact with the positive electrode can be preferably selected for the position where the acidic group-containing polymer is arranged. Arranging at such a location is advantageous in terms of preventing in advance a phenomenon in which the acidic group-containing polymer is modified by the high electrical potential of the positive electrode. Thus, a lithium ion secondary battery that has superior durability with respect to charge/discharge cycling can be realized.

The negative electrode of the lithium ion secondary battery disclosed herein is typically provided with a negative electrode mixture layer containing the negative electrode active material. In a preferable aspect, the acidic group-containing polymer is arranged on this negative electrode mixture layer. A battery employing this configuration can be preferably produced by, for example, applying a solution of the acidic group-containing polymer to the surface of the negative electrode mixture layer and drying. The amount of the acidic group-containing polymer arranged per square centimeter of surface area of the negative electrode mixture layer can be, for example, about 0.01 mg to 0.20 mg.

Another invention disclosed herein is a method for producing a lithium ion secondary battery having a positive electrode having a positive electrode active material containing manganese, a negative electrode having a negative electrode mixture layer containing a negative electrode active material, an electrolyte (and typically, a non-aqueous electrolyte solution) interposed between the positive electrode and the negative electrode, and an acidic group-containing polymer arranged on the negative electrode mixture layer. This method includes a step of arranging the acidic group-containing polymer on the negative electrode mixture layer by applying an organic solvent solution of the polymer to the negative electrode mixture layer followed by removing the organic solvent from the solution. In addition, the method can contain a step of constructing a battery by housing the negative electrode, on which the polymer is arranged, and the positive electrode in a container together with the electrolyte. According to this method, a lithium ion secondary battery can be suitably produced that demonstrates superior charge/discharge cycle characteristics despite having a configuration provided with a positive electrode active material that contains Mn.

The lithium ion secondary battery disclosed herein is preferable for use as a secondary battery installed in a vehicle due to its superior charge/discharge cycle characteristics as described above. For example, it can be preferably used as a power supply for a motor (electric motor) of a vehicle such as an automobile. Thus, according to the present invention, a vehicle is provided that is equipped with any of the lithium ion secondary batteries disclosed herein (which can be a battery produced according to any of the methods disclosed herein).

### BRIEF DESCRIPTION OF DRAWINGS

FIG. 1 is a partial cross-sectional perspective view schematically showing a configuration of a lithium ion secondary battery according to an embodiment;

FIG. 2 is a schematic cross-sectional view showing positive and negative electrode sheets and a separator that compose a secondary battery according to an embodiment;

FIG. 3 is a schematic cross-sectional view showing positive and negative electrode sheets and a separator that compose a secondary battery according to another embodiment; and

FIG. 4 is a side view schematically showing a vehicle (automobile) provided with a secondary battery according to an embodiment.

### DESCRIPTION OF EMBODIMENTS

The following provides an explanation of preferred embodiments of the present invention. Matters required for carrying out the present invention other than matters specifically mentioned in the present specification can be understood to be design matters for a person with ordinary skill in the art based on the prior art in the relevant field. The present invention can be carried out based on the contents disclosed in the present specification and common general technical knowledge in the relevant field.

The technology disclosed herein can be applied to various types of lithium ion secondary batteries constructed using a positive electrode provided with a positive electrode active material containing Mn (Mn-containing positive electrode active material). The Mn-containing positive electrode active material can be, for example, a manganese compound having a spinel, layered rock salt or olivine crystal structure.

A typical example of an Mn-containing positive electrode active material is lithium manganese oxide having a spinel crystal structure. Examples of this type of lithium manganese oxide include LiMn₂O₄ as well as compounds of a composition in which a portion of the Mn is substituted with another metal element (lithium manganese oxide having a partially substituted spinel structure). For example, a spinel compound represented by the general formula: LiM_{y}Mn_{2-y}O₄ can be preferably employed as a positive electrode active material in the technology disclosed herein. In the above general formula, y is typically a number that satisfies 0≦y≦0.7, and preferably satisfies 0.4≦y≦0.6. In the case of 0<y, M in the above general formula can be one type or two or more types of elements selected from Li, Mg, Al, Ni, Fe, Co, Cr, Cu, Be, B, Na, K, Ca, Si, Ge and Ti. In terms of the number of atoms, an oxide of a composition in which 50% or more of metal elements other than lithium are Mn is preferable. One specific example thereof is LiNi_{0.5}Mn₄.

Another example of an Mn-containing positive electrode active material is lithium manganese oxide having a layered rock salt crystal structure. Examples of this type of lithium manganese oxide include LiMnO₂ as well as compounds of a composition in which a portion of the Mn is substituted with another metal element (for example, one type or two or more types of metal elements selected from Li, Mg, Al, Ni, Fe, Co, Ti, Zr and Nb). In terms of the number of atoms, an oxide of a composition in which 50% or more of metal elements other than lithium are Mn is preferable. Specific examples thereof include LiNi_{0.5}Mn_{0.5}O₂, LiNi_{1/3}Co_{1/3}Mn_{1/3}O₂ and Li_{4/3}Mn_{2/3}O₂.

Another example of an Mn-containing positive electrode active material is a lithium manganese oxide having an olivine crystal structure. For example, the use of an olivine compound represented by the general formula: LiMₓMn₁₋ₓZO₄ is preferable. In the above general formula, Z can be P and/or Si. x is typically a number that satisfies 0≦x≦0.6 and preferably satisfies 0≦x≦0.5. In the case of 0<x, M in the above general formula can be one type or two or more types of elements selected from Fe, Mg, Ni and Co. Specific examples thereof include LiMnPO₄ and LiFe_{0.1}Mn_{0.9}PO₄.

For this type of Mn-containing positive electrode active material (typically, in particulate form), a lithium manganese oxide powder prepared and provided by a conventionally known method can be used as is. For example, lithium manganese oxide powder substantially composed of secondary particles having a mean particle diameter within the range of about 1 μm to 25 μm (typically, about 2 μm to 15 μm) can be preferably employed as a positive electrode active material in the technology disclosed herein.

A typical form of a positive electrode having this active material is that a positive electrode mixture containing the active material (typically, containing the active material as a main component, or in other words, containing the active material as a component that accounts for 50% by weight or more of the positive electrode mixture) retained on a current collector. An electrically conductive material such as aluminum can be preferably employed for the constituent material of the current collector (positive electrode current collector) in the same manner as in common conventional lithium ion secondary batteries. There are no particular limitations on the shape of the current collector, and can be in the shape of a rod, plate, sheet, foil or mesh. A preferable example of a positive electrode in the technology disclosed herein is a positive electrode of a form in which a layer of a positive electrode mixture is provided on one side or both sides of a current collector in the form of a sheet or foil.

The positive electrode mixture can contain an electrically conductive material, binder and the like as necessary in addition to the positive electrode active material. A carbon material such as carbon black (for example, acetylene black) or graphite powder can be preferably used for the electrically conductive material in the same manner as electrically conductive materials present in the electrodes of common lithium ion secondary batteries. Examples of the binders that can be used include polyvinylidene fluoride (PVDF), carboxymethyl cellulose (CMC) and styrene butadiene rubber (SBR). Although there are no particular limitations thereon, the amount of the electrically conductive material that can be used based on 100 parts by weight of the positive electrode active material is, for example, 1 to 20 parts by weight (and preferably 5 to 15 parts by weight). In addition, the amount of binder that can be used based on 100 parts by weight of the positive electrode active material is, for example, 0.5to 10 parts by weight.

The positive electrode mixture layer can be preferably fabricated by, for example, applying a composition, of a form in which the positive electrode active material and an electrically conductive material used as necessary are dispersed in a liquid solvent containing a suitable solvent and a binder (typically, in the form of a paste or slurry), to a current collector, drying and then pressing as desired. Any of water, an organic solvent and a mixed solvent thereof can be used for the solvent.

A suitable material selected from various materials typically known to be able to function as a negative electrode active material of a lithium ion secondary battery can be employed for the negative electrode active material used in the technology disclosed herein. Preferable examples of active materials include particulate carbon materials (carbon particles) containing a graphite structure (layered structure) at least in a portion thereof The physical state (external shape) of the negative electrode active material is preferably particulate. For example, carbon particles having a mean particle diameter of about 5 μm to 50 μm can be used preferably.

A typical example of one form of a negative electrode having this active material is that in which a negative electrode mixture containing the active material (typically, mainly containing the active material, or in other words, containing the active material as a component that accounts for 50% by weight or more of the electrode mixture) is retained on a current collector. An electrically conductive metallic material such as copper can be preferably employed for the constituent material of the current collector (negative electrode current collector) in the same manner as in common conventional lithium ion secondary batteries. The shape of the current collector can be of various shapes, such as that of rod, plate, sheet, foil or mesh in the same manner as the positive electrode. A preferable example of a negative electrode is a negative electrode of a form in which a layer of a negative electrode mixture is provided on one side or both sides of a current collector in the form of a sheet or foil.

The negative electrode mixture can contain an electrically conductive material, binder and the like as necessary in addition to the negative electrode active material in the same manner as the positive electrode. Although there are no particular limitations thereon, the amount of binder that can be used based on 100 parts by weight of the negative electrode active material is, for example, 0.5 to 10 parts by weight. The negative electrode mixture layer can be preferably fabricated by applying a composition, of a form in which the negative electrode active material is dispersed in a liquid solvent containing a suitable solvent and a binder, to a current collector, drying and then pressing as desired in the same manner as the positive electrode.

A liquid electrolyte containing a non-aqueous solvent and a lithium salt (supporting electrolyte) capable of being dissolved in the solvent (non-aqueous electrolyte solution) can be preferably used for the electrolyte interposed between the positive electrode and the negative electrode. The electrolyte may also be a solid (gel) electrolyte in which a polymer is added to the electrolyte solution. One type or two or more types of non-aqueous solvents selected from non-aqueous solvents known to be able to be commonly used in the electrolytes of lithium ion secondary batteries can be used for the non-aqueous solvent, examples of which include carbonates, esters, ethers, nitriles, sulfones and lactones.

One type or two or more types of supporting electrolytes selected from various types of lithium salts known to be able to function as supporting electrolytes of lithium ion secondary batteries can be used for the supporting electrolyte, examples of which include LiPF₆, LiBF₄, LiN(SO₂CF₃)₂, LiN(SO₂C₂F₅)₂, LiCF₃SO₃, LiC₄F₉SO₃, LiC(SO₂CF₃)₃ and LiClO₄. There are no particular limitations on the concentration of the supporting electrolyte (supporting salt), and can be made to be roughly the same as that of conventional lithium ion secondary batteries, for example. Normally, a non-aqueous electrolyte solution can be preferably used that contains a supporting electrolyte at a concentration of about 0.1 mol/L to 5 mol/L (and for example, about 0.8 mol/L to 1.5 mol/L).

In a preferable aspect of the lithium ion secondary battery disclosed herein, an electrode body obtained by winding layers of a sheet-shaped positive electrode and sheet-shaped negative electrode (wound electrode body) is housed in a container together with a non-aqueous electrolyte solution. There are no particular limitations on the shape of the lithium ion secondary battery (outer shape of the container), and can be that of a cylinder, rectangle or coin, etc.

In a preferable aspect, a separator is interposed between the positive electrode and the negative electrode. A separator similar to a separator used in an ordinary lithium ion secondary battery can be used for the separator, and there are no particular limitations thereon. For example, a porous sheet or a non-woven fabric composed of a resin such as polyethylene (PE), polypropylene (PP), polyester, cellulose or polyamide, can be used. A configuration may also be employed in which the electrolyte also functions as a separator in the case of a lithium ion secondary battery that uses a solid electrolyte.

The lithium ion secondary battery disclosed herein has an acidic group-containing polymer arranged between the positive electrode active material and the negative electrode active material. The acidic group (acidic functional group)of the polymer can be one or both of a carboxyl group (—COOH) and a sulfonic acid group (—SO₃H). A preferable example of a polymer is that in which the acidic group is substantially only a carboxyl group. This type of acidic group-containing polymer is typically a polymer with a monomer composition that contains a monomer having an acidic group (acidic group-containing monomer).

Typical examples of the acidic group-containing monomer include compounds having a carboxyl group and an ethylenic unsaturated group in a molecule thereof Examples of the ethylenic unsaturated group include an acryloyl group, methacryloyl group, vinyl group and allyl group. Specific examples of such compounds include monocarboxylic acids such as acrylic acid, methacrylic acid or crotonic acid, and dicarboxlyic acids such as maleic acid, itaconic acid or citraconic acid. Preferable examples of acidic group-containing monomers include acrylic acid and methacrylic acid. In particular, an acidic group-containing polymer having a monomer composition that contains acrylic acid is preferable.

The acidic group-containing polymer may be a polymer having a monomer composition composed of one type or two or more types of an acidic group-containing monomer, or may be a copolymer of an acidic group-containing monomer and another monomer (namely, a monomer not having an acidic group). Various types of compounds capable of copolymerizing with an acidic group-containing monomer can be used for the other monomer. A compound having an ethylenic unsaturated group is preferable, and a compound having an acryloyl group or methacryloyl group (and particularly an acryloyl group) is particularly preferable. Alternatively, the acidic group-containing polymer may also be an acidic group-containing polymer with a monomer composition that substantially does not contain a monomer not having an acidic group.

In a preferable aspect of an acidic group-containing polymer in the technology disclosed herein, 50 to 100% by weight (more preferably 75 to 100% by weight, and for example, 90 to 100% by weight) of the monomer composition is an acidic group-containing monomer. If the polymerization ratio of the acidic group-containing monomer is excessively low, the ability of the acidic group-containing polymer to trap Mn ions decreases, thereby potentially making it difficult for the polymer to adequately demonstrate the effect of improving charge/discharge cycle characteristics.

This acidic group-containing polymer can be easily produced in accordance with a conventionally known method, or can be easily acquired as a commercially available product. Normally, an acidic group-containing polymer having a weight average molecular weight (Mw) of 100×10⁴ or less is used suitably, and for example, that having an Mw of 50×10⁴ or less can be used preferably. If the Mw is excessively high, inconvenience may occur such as it being difficult to dissolve the acidic group-containing polymer in a solvent or the viscosity of the polymer solution becoming excessively high in the case of arranging the polymer by removing the solvent from a solvent solution of the polymer. In addition, the Mw of the acidic group-containing polymer is preferably 1×10⁴ or more, and normally is more preferably 2×10⁴ or more (and for example, 5×10⁴ or more). If the Mw is excessively low, all or a portion of the acidic group-containing polymer may easily migrate from the initially arranged location (and be lost) due to stress and the like which may be applied during production or use of the battery.

The acidic group-containing polymer is arranged at a location that enables it to trap Mn ions that have eluded from the positive electrode active material in a pathway by which the Mn ions reach the negative electrode active material. The acidic group-containing polymer is preferably arranged in a form in which it is spread out in a thin shape (in the manner of, for example, a film or sheet) to enable it to efficiently trap Mn ions while inhibiting increases in internal resistance. For example, by applying a solution of the acidic group-containing polymer to a surface of the positive electrode mixture layer and/or negative electrode mixture layer that faces to a mixture layer of a counter electrode, or, in the case of a configuration having a separator, a surface of the separator that faces to the positive electrode mixture layer and/or a surface of the separator that faces to the negative electrode mixture layer, and then drying that solution, the acidic group-containing polymer can be arranged at the location thereof. Alternatively, a sheet (which can be a non-porous sheet or a porous sheet) prepared by film making the acidic group-containing polymer may be interposed between the positive electrode and the negative electrode (or, in the case of a configuration having a separator, between the positive electrode and the separator and/or between the negative electrode and the separator).

In a preferable aspect, the acidic group-containing polymer is arranged at a location that is not in direct contact with the positive electrode. This is advantageous in terms of preventing in advance a phenomenon in which the acidic group-containing polymer is subjected to modification (which can be crosslinking, decomposition or conversion of functional groups and the like) due to the high electrical potential of the positive electrode. For example, in an aspect in which the acidic group-containing polymer is arranged on the surface of the negative electrode mixture layer, or, in a configuration having a separator, an aspect in which the acidic group-containing polymer is arranged on the surface of the separator that faces the negative electrode mixture layer, and a configuration in which a sheet of the acidic group-containing polymer is arranged between the negative electrode and the separator, etc. can be preferably employed.

To arrange the polymer on the surface of the negative electrode mixture layer, a method in which the solvent is removed from a solution (for example, by drying the solution) in which the acidic group-containing polymer is dissolved or uniformly dispersed in a suitable solvent (polymer solution) can be preferably employed. Water, organic solvent or any mixed solvent thereof can be used for the solvent. In a preferable aspect, the acidic group-containing polymer is arranged by using a solution containing the polymer in a solvent containing an organic solvent. As a result thereof, a lithium ion secondary battery can be realized that demonstrates more superior charge/discharge cycle characteristics. The solvent containing an organic solvent can be a solvent composed only of one type or two or more types of organic solvent or a mixed solvent of an organic solvent and water (and typically, a solvent composed mainly of an organic solvent, or in other words, a solvent in which the component that accounts for 50% by volume or more of the solvent is an organic solvent). Examples of organic solvents that can be suitably selected and used for the above-mentioned organic solvent include lower alcohols having about 1 to 4 carbon atoms, acetone, tetrahydrofuran, N-methylpyrrolidone, acetic acid esters (and typically, esters of lower alcohols having about 1 to 4 carbon atoms and acetic acid, such as ethyl acetate) and carbonic acid esters. Preferable examples of organic solvents include methyl alcohol, ethyl alcohol and isopropyl alcohol.

The acidic group-containing polymer can be arranged on the negative electrode mixture layer (or in other words, the acidic group-containing polymer can be coated onto the surface of the negative electrode mixture layer) by, for example, coating this polymer solution onto the surface of the negative electrode mixture layer followed by drying. A commonly used method can be suitably employed to coat the polymer solution, examples of which include the use of a coating machine such as a slit coater, immersing the negative electrode mixture layer in the polymer solution (dip coating) and spraying the polymer solution onto the surface of the negative electrode mixture layer (spray coating). By applying the polymer solution to the surface of a preliminarily formed negative electrode mixture layer in this manner, the acidic group-containing polymer can be concentrated (unevenly distributed) at the location of the negative electrode where Mn ions initially reach. According to this configuration, Mn ions can be efficiently trapped using a smaller amount of the acidic group-containing polymer in comparison with a configuration in which, for example, the acidic group-containing polymer is uniformly arranged extending to the inside of the negative electrode mixture layer. Thus, charge/discharge cycle characteristics can be effectively improved while suppressing the occurrence of problems attributable to the presence of the acidic group-containing polymer (such as increases in internal resistance). In a battery provided with a negative electrode having a configuration in which another layer (such as a porous ceramic layer) is further formed on the negative electrode mixture layer, the acidic group-containing polymer may be arranged on the surface of that layer.

In a lithium ion secondary battery of an aspect in which the acidic group-containing polymer is arranged on the negative electrode mixture layer, normally the arranged amount of the polymer is suitably 1.00 mg or less per square centimeter of the surface area (formed area) of the negative electrode mixture layer (namely, 1.00 mg/cm² or less), and is preferably 0.50 mg/cm² or less (more preferably, 0.20 mg/cm² or less, typically less than 0.20 mg/cm² and for example, 0.18 mg/cm² or less). If the arranged amount is excessively large, there may be a tendency for battery performance to decrease due to impairment of material exchange between the negative electrode mixture layer and the outside by the acidic group-containing polymer (such as impairment of the migration of lithium ions or electrolyte solution). There are no particular limitations on the lower limit of the arranged amount of the acidic group-containing polymer. However, in order to effectively demonstrate the effects brought about by the acidic group-containing polymer, normally the arranged amount thereof is suitably 0.01 mg/cm² or more and preferably 0.03 mg/cm² or more. In an aspect in which the acidic group-containing polymer is arranged on the surface of the separator on the side of the negative electrode mixture layer, it is suitable to set the arranged amount of the polymer per square centimeter of separator surface area within the above-mentioned range.

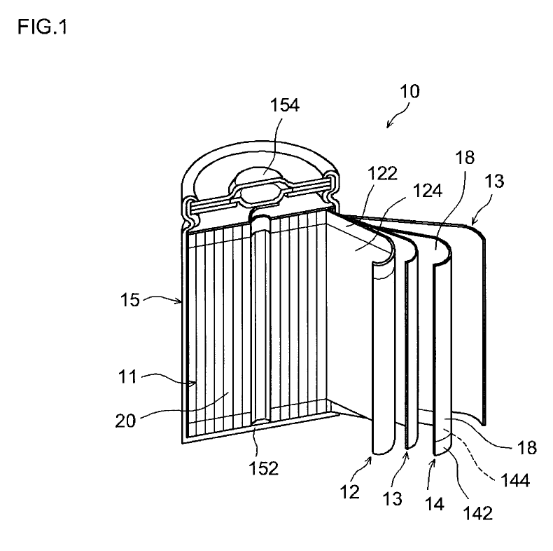

The following provides an explanation of one embodiment of the lithium ion secondary battery disclosed herein while referring to the drawings. As shown in FIG. 1, a lithium ion secondary battery 10 has a configuration in which an electrode body 11 provided with a positive electrode 12 and a negative electrode 14 is housed in a battery case (container) 15 of a shape capable of housing the electrode body together with a non-aqueous electrolyte solution 20. At least a portion of the non-aqueous electrolyte solution 20 is impregnated in the electrode body 11.

The electrode body 11 is formed by superimposing the positive electrode (positive electrode sheet) 12, having a configuration in which a positive electrode mixture layer 124 containing a positive electrode active material is provided on a positive electrode current collector 122 in the form of a long sheet, and the negative electrode (negative electrode sheet) 14, having a configuration in which a negative electrode mixture layer 144 containing a negative electrode active material is provided on a negative electrode current collector 142 in the form of a long sheet, with separators 13 in form of two long sheets, and winding these components into the shape of a cylinder.

The battery case 15 is provided with a bottomed cylindrical case body 152 and a lid 154 that covers the opening thereof. Both the lid 154 and the case body 152 are made of metal, are mutually insulated, and are electrically connected to the positive electrode and negative electrode current collectors 122 and 142, respectively. Namely, in this lithium ion secondary battery 10, the lid 154 also functions as a positive electrode terminal, while the case body 152 also functions as a negative electrode terminal.

A portion where the positive electrode current collector 122 is exposed without being provided with the positive electrode mixture layer (positive electrode mixture layer non-formed portion) is provided on one edge along the lengthwise direction of the current collector 122. Similarly, a portion where the negative electrode current collector 142 is exposed without being provided with the negative electrode mixture layer (negative electrode mixture layer non-formed portion) is provided on one edge along the lengthwise direction of the current collector 142. The lid 154 and the case body 152 are respectively connected to these exposed portions.

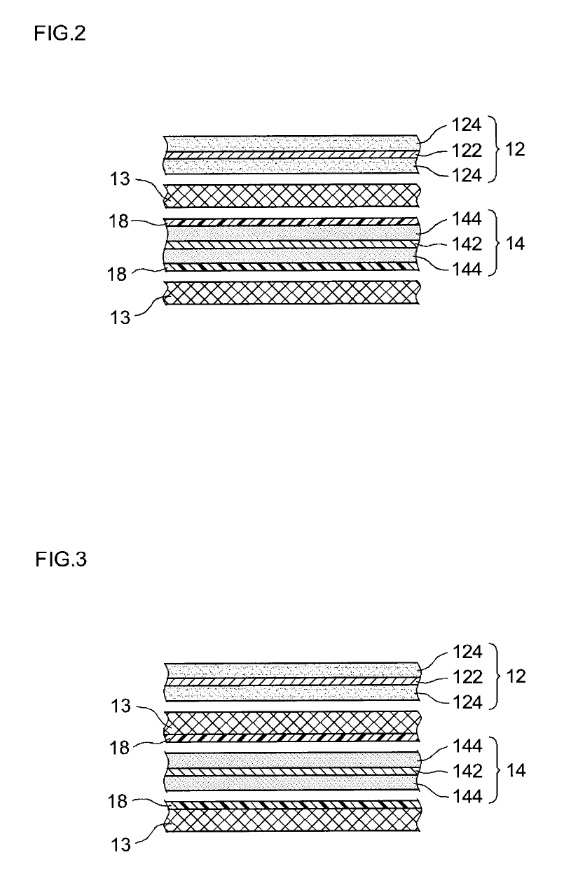

As shown in FIG. 2, an acidic group-containing polymer 18 (such as polyacrylic acid) is arranged on the negative electrode mixture layer 144 that composes the negative electrode sheet 14. The electrode body 11 is formed by superimposing the negative electrode sheet 14 coated with the acidic group-containing polymer 18 in this manner with another members and winding. Note that although FIG. 2 shows the example of a configuration in which the polymer 18 is arranged on the entire surface of the negative electrode mixture layer 144 provided on both sides of the negative electrode current collector 142, the polymer 18 may only be arranged on the negative electrode mixture layer 144 provided on one side, or the polymer 18 may be arranged over a range that extends only a portion of the surface of the negative electrode mixture layer 144. Alternatively, as in the variation shown in FIG. 3, the acidic group-containing polymer 18 may be arranged on the surface of the separator 13 on the side of the negative electrode mixture layer 144, and the electrode body 11 may be formed by superimposing the separator 13 coated with the acidic group-containing polymer 18 in this manner with another members and winding.

The technology disclosed herein can be preferably applied to a lithium ion secondary battery for use under charge/discharge conditions at which the upper limit voltage between terminals can be 4.5 V or more (for example, 41 V or more and particularly, 4.8 V or more, and typically 7 V or less and, for example, 5.5 V or less). A preferable example of such a battery is a so-called 5 V class lithium ion secondary battery provided with a spinal-type lithium manganese oxide for the positive electrode active material. A method of using any of the lithium ion secondary batteries disclosed herein (and preferably, a secondary battery provided with a spinel-type lithium manganese oxide for the positive electrode active material) under charge/discharge conditions in which the upper limit voltage can be 4.5 V or more (for example, 4.7 V or more and particularly 4.8 V or more, and typically 7 V or less, and for example, 5.5 V or less), a power supply system provided with the lithium ion secondary battery (which can also be in the form of an assembled battery) and a mechanism for controlling the battery to charge/discharge conditions set so as to attain the above-mentioned upper limit voltage, and a vehicle equipped with the power supply system, are included in the matters disclosed by this specification.

Although the following provides an explanation of several examples relating to the present invention, this explanation is not intended to limit the present invention to that indicated in these specific examples.

### EXAMPLE 1

A lithium manganese oxide having a composition represented by LiNi_{0.5}Mn_{1.5}O₄ was used as a positive electrode active material. 425 g of the lithium manganese oxide powder having the above-mentioned composition and 50 g of acetylene black were added to a solution obtained by dissolving 25 g of polyvinylidene fluoride (PVDF) as binder in 625 mL of N-methylpyrrolidone (NMP) followed by uniformly mixing to prepare a composition in the form of a paste or slurry (positive electrode mixture layer-forming composition). This composition was then coated onto both sides of a long piece of aluminum foil (positive electrode current collector) having a thickness of 15 μm and dried. The coated amount of the composition (based on the solid content thereof) was adjusted to be about 15 mg/cm² as the total of both sides. After drying, the positive electrode current collector was pressed so that the total thickness of the positive electrode current collector and the positive electrode mixture layers on both sides thereof was about 70 μm to produce a sheet-shaped positive electrode (positive electrode sheet).

462.5 g of graphite powder were added to a solution obtained by dissolving 37.8 g of PVDF in 625 mL of NMP followed by uniformly mixing to prepare a composition in the form of a paste or slurry (negative electrode mixture layer-forming composition). This composition was then coated onto both sides of a long piece of copper foil (negative electrode current collector) having a thickness of 10 μm and dried. The coated amount of the composition (based on the solid content thereof) was adjusted to be about 9 mg/cm² as the total of both sides. After drying, the negative electrode current collector was pressed so that the total thickness was about 70 μm to produce a sheet-shaped negative electrode (negative electrode sheet).

The negative electrode sheet (not coated with polymer) was laminated with the above-mentioned positive electrode sheet and two, long separator sheets, and the laminate was then wound in the lengthwise direction to produce a wound electrode body. Porous polyethylene sheets having a thickness of 25 μm were used for the separator sheets. This electrode body was then housed in a cylindrical outer case together with an electrolyte solution (the electrolyte solution used had a composition consisting of dissolving LiPF₆ at a concentration of 1 mol/L in a solvent obtained by mixing EC and DEC at a volume ratio of 3:7) to construct an 18650-type lithium ion secondary battery (Battery Sample 1).

### EXAMPLE 2

The negative electrode sheet produced in Example 1 was immersed for about 5 seconds in a 2.5% by weight ethyl alcohol solution of polyacrylic acid (weight average molecular weight: 25×10⁴) followed by lifting out of the solution and drying under reduced pressure at 120° C. to coat polyacrylic acid onto the surface of the negative electrode mixture layer. The coated amount of polyacrylic acid as calculated from the weight difference before and after coating and the surface area of the negative electrode mixture layer was 0.15 mg per square centimeter of surface area of the negative electrode mixture layer (namely, 0.15 mg/cm²). Battery Sample 2 was then constructed in the same manner as Example 1 with the exception of using this negative electrode sheet coated with polyacrylic acid in this manner.

### EXAMPLE 3

Polyacrylic acid was coated onto the negative electrode mixture layer in the same manner as Example 2 with the exception of changing the polyacrylic acid concentration in the polyacrylic acid ethyl alcohol solution to 1.0% by weight. The coated amount was 0.10 mg/cm². Battery Sample 3 was then constructed in the same manner as Example 1 with the exception of using this negative electrode sheet coated with polyacrylic acid in this manner.

### EXAMPLE 4

Polyacrylic acid was coated onto the negative electrode mixture layer in the same manner as Example 2 with the exception of using a 2.5% by weight aqueous solution of polyacrylic acid instead of the 2.5% by weight ethyl alcohol solution of polyacrylic acid used in Example 2. The coated amount was 0.10 mg/cm². Battery Sample 4 was then constructed in the same manner as Example 1 with the exception of using this negative electrode sheet coated with polyacrylic acid in this manner.

### EXAMPLE 5

Polyethylacrylate was coated onto the negative electrode mixture layer in the same manner as Example 2 with the exception of using a 2.5% by weight toluene solution of polyethylacrylate (weight average molecular weight: 25×10⁴) instead of the 2.5% by weight ethyl alcohol solution of polyacrylic acid used in Example 2. The coated amount was 0.10 mg/cm². Battery Sample 5 was then constructed in the same manner as Example 1 with the exception of using this negative electrode sheet coated with polyethylacrylate in this manner.

### EXAMPLE 6

Sodium polyacrylate was coated onto the negative electrode mixture layer in the same manner as Example 2 with the exception of using a 2.5% by weight aqueous solution of sodium polyacrylate (polymerization degree: 22×10³ to 70×10³) instead of the 2.5% by weight ethyl alcohol solution of polyacrylic acid used in Example 2. The coated amount was 0.10 mg/cm². Battery Sample 6 was then constructed in the same manner as Example 1 with the exception of using this negative electrode sheet coated with sodium polyacrylate in this manner.

### EXAMPLE 7

In this example, lithium nickel oxide having the composition represented by LiNi_{0.8}Co_{0.15}Al_{0.05}O₄ was used for the positive electrode active material. A positive electrode mixture layer-forming composition was prepared in the same manner as Example 1 using this lithium nickel oxide powder, and this composition was coated onto both sides a long piece of aluminum foil (positive electrode current collector) having a thickness of 15 μm and dried. The coated amount of the composition (based of the solid content) as the combined total for both sides was adjusted to about 13 mg/cm². After drying, the coated positive electrode current collector was pressed so that the total thickness of the positive electrode current collector and positive electrode mixture layers on both sides thereof was about 65 μm to produce a sheet-shaped positive electrode (positive electrode sheet). This positive electrode sheet was then laminated with a negative electrode sheet (not coated with polymer) and two long separator sheets to construct a Battery Sample 7 in the same manner as Example 1.

### EXAMPLE 8

In this example, Battery Sample 8 was constructed in the same manner as Example 1 with the exception of combining the use of the positive electrode sheet of Example 7 with the polyacrylic acid-coated negative electrode sheet of Example 2.

The characteristics of the Battery Samples 1 to 8 obtained in the manner described above were evaluated as indicated below. The results are shown in Table 1 along with the general compositions of each of the battery samples.

[Measurement of Initial Discharge Capacity]

A procedure consisting of constant-current charging each battery sample at a rate of 0.1 C of the theoretical capacity (wherein, 1 C is the current value enabling the battery to be fully charged in 1 hour) to a voltage between both terminals of 4.9 V (4.1 V for Battery Samples 7 and 8), and a procedure consisting of constant-current discharging at 0.1 C to a voltage between both terminals of 3.0 V, were repeated for 3 cycles. Next, after constant-current charging to 4.9 V (4.1 V for Battery Samples 7 and 8) at 1 C and then constant-voltage charging until the total charging time reached 2 hours, the batteries were constant-current discharged to 3.0 V at a rate of 1 C followed by measurement of capacity as this time as initial discharge capacity (mAh). The procedures described above were carried out at 25° C.

[Evaluation of Cycle Characteristics]

After measuring initial discharge capacity as described above, a procedure consisting of constant-current charging the battery samples at a rate of 1 C to 4.9 V (4.1 V for Battery Samples 7 and 8) and then constant-voltage charging until the total charging time reached 2 hours, and a procedure consisting of constant-current discharging the batteries at a rate of 1 C to 3.0 V, were carried out for 100 cycles. The above procedures were carried out at 25° C. The ratio of discharge capacity of the 100th cycle to discharge capacity of the 1st cycle was calculated as capacity retention rate.

TABLE 1

| | Positive electrode active | | | Coated amount | Initial capacity | Capacity retention rate |
|---|---|---|---|---|---|---|
| No. | material | Coated polymer | Solvent | (mg/cm²) | (mAh) | (%) |
| 1 | LiNi_{0.5}Mn_{1.5}O₄ | — | — | — | 1128 | 61 |
| 2 | LiNi_{0.5}Mn_{1.5}O₄ | Polyacrylic acid | Ethyl alcohol | 0.15 | 1114 | 69 |
| 3 | LiNi_{0.5}Mn_{1.5}O₄ | Polyacrylic acid | Ethyl alcohol | 0.10 | 1125 | 64 |
| 4 | LiNi_{0.5}Mn_{1.5}O₄ | Polyacrylic acid | Water | 0.10 | 885 | 62 |
| 5 | LiNi_{0.5}Mn_{1.5}O₄ | Polyethylacrylate | Toluene | 0.10 | 1100 | 61 |
| 6 | LiNi_{0.5}Mn_{1.5}O₄ | Sodium polyacrylate | Water | 0.10 | 770 | 59 |
| 7 | LiNi_{0.8}Co_{0.15}Al_{0.05}O₂ | — | — | — | 1095 | 91 |
| 8 | LiNi_{0.8}Co_{0.15}Al_{0.05}O₂ | Polyacrylic acid | Ethyl alcohol | 0.10 | 1096 | 89 |

As can be understood from the table, among Samples 1 to 6 provided with an Mn-containing positive electrode active material, the capacity retention rates of Samples 2 to 4, in which polyacrylic acid was coated onto the negative electrode mixture layer, improved as compared with Sample 1 that was not coated with polymer. In particular, the capacity retention rates demonstrated by Samples 2 and 3, in which an ethyl alcohol solution of polyacrylic acid was used for coating, were clearly higher than that of Sample 4 in which an aqueous solution was used. In Sample 2 in particular, capacity retention rate improved by 10% or more as compared with Sample 1 not coated with polymer. In addition, in Sample 4 in which an aqueous solution was used, in contrast to initial capacity having decreased despite improvement of capacity retention rate, Samples 2 and 3, which used ethyl alcohol solutions, maintained an initial capacity that was comparable to that of Sample 1.

In contrast, in Sample 5 coated with a homopolymer of ethyl acrylate not having an acidic functional group, the effect of improving capacity retention rate was not observed. In Sample 6 coated with a salt of polyacrylic acid instead of polyacrylic acid, in addition to capacity retention rate being slightly lower than that of Sample 1, initial capacity also decreased. It should be noted that both capacity retention rate and initial capacity became lower than those of Sample 1 when the coated amount of the polyacrylic acid in Example 2 was changed to 0.20 mg/cm². In addition, when a battery sample was similarly produced by coating the same polyacrylic acid ethyl alcohol solution as Example 2 onto the surface of the positive electrode mixture layer instead of onto the surface of the negative electrode mixture layer, differing from Example 2, there was no improvement of capacity retention rate observed.

On the other hand, as can be understood from a comparison with Samples 7 and 8, in batteries using a positive electrode active material that does not contain Mn, the effect of improving charge/discharge cycle characteristics as demonstrated by coating with an acidic group-containing polymer was no longer observed. This is thought to be due to absence of the occurrence of the problem of a decrease in charge/discharge cycle characteristics attributable to elution of Mn ions in batteries using a positive electrode active material that does not contain Mn. Note that the presence of Mn was confirmed when Battery Sample 1 was disassembled following the cycle characteristics evaluation test and the surface of the negative electrode thereof was analyzed by inductively coupled plasma (IPC) optical emission spectrometry. This result indicates that elution of Mn ions and deposition thereof on the negative electrode occurred in Battery Sample 1 as a result of conducting the cycle characteristics evaluation test.

Although the above has provided a detailed explanation of the present invention, the above-mentioned embodiments are merely examples thereof, and various variations and modifications of the above-mentioned specific examples are also included in the invention disclosed herein.

### INDUSTRIAL APPLICABILITY

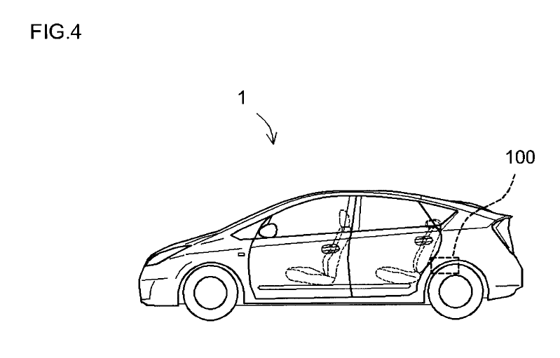

The lithium ion secondary battery provided by the technology disclosed herein can be used as a lithium ion secondary battery in various types of applications as a result of demonstrating the superior performance (such as charge/discharge cycle characteristics) previously described. For example, the lithium ion secondary battery can be preferably used as a power supply for a motor (electric motor) installed in a vehicle such as an automobile. This lithium ion secondary battery may also be used in the form of an assembled battery in which a plurality thereof is connected in series and/or in parallel. Thus, according to the technology disclosed herein, a vehicle (typically, an automobile, and particularly an automobile provided with an electric motor in the manner of a hybrid vehicle, electric vehicle or fuel cell vehicle) 1 can be provided that is provided with this lithium ion secondary battery (which can also be in the form of an assembled battery) 100 as schematically shown in FIG. 4.

1. A lithium ion secondary battery, comprising:
a positive electrode having a positive electrode active material containing manganese;
a negative electrode having a negative electrode active material;
a non-aqueous electrolyte solution interposed between the positive electrode and the negative electrode; and
an acidic group-containing polymer arranged between the positive electrode active material and the negative electrode active material.

2. The battery according to claim 1, wherein the polymer is a polymer that contains at least one of acrylic acid and methacrylic acid as a monomer composition.

3. The battery according to claim 1, wherein the polymer is polyacrylic acid.

4. The battery according to claim 1, wherein the polymer is arranged by removing an organic solvent from an organic solvent solution of the polymer.

5. The battery according to claim 1, wherein the polymer is arranged at a location not in direct contact with the positive electrode.

6. (canceled)

7. The battery according to claim 6, wherein 0.01 mg to 0.20 mg of the polymer is arranged per square centimeter (cm²) of surface area of the negative electrode mixture layer.

8. The battery according to claim 1, wherein the positive electrode active material is a spinel-type lithium manganese oxide.

9. A method for producing a lithium ion secondary battery having a positive electrode having a positive electrode active material containing manganese, a negative electrode having a negative electrode mixture layer containing a negative electrode active material, a non-aqueous electrolyte solution interposed between the positive electrode and the negative electrode, and an acidic group-containing polymer arranged on the negative electrode mixture layer,
the method comprising:
a step of arranging the acidic group-containing polymer on the negative electrode mixture layer by applying an organic solvent solution of the polymer to the negative electrode mixture layer followed by removing the organic solvent from the solution; and
a step of constructing a battery by housing the negative electrode, on which the polymer is arranged, and the positive electrode in a container together with the electrolyte solution.

10. A vehicle comprising the lithium ion secondary battery according to claim 1.
